(19) United States
(12) Patent Application Publication
(10) Pub. No.: US 2024/0332506 A1
(43) Pub. Date: Oct. 3, 2024

(54) HYBRID CATHODE STACK OF A BATTERY CELL

(71) Applicant: Apple Inc., Cupertino, CA (US)

(72) Inventors: Rachel Ann R Villamayor Huang, San Jose, CA (US); OuJung Kwon, Cupertino, CA (US)

(21) Appl. No.: 18/583,600

(22) Filed: Feb. 21, 2024

Related U.S. Application Data
(60) Provisional application No. 63/455,857, filed on Mar. 30, 2023.

(51) Int. Cl. H01M 4/36; H01M 4/02; H01M 4/131; H01M 4/1391; H01M 4/505; H01M 4/525; H01M 4/58

(52) U.S. Cl. CPC H01M 4/366; H01M 4/131; H01M 4/1391; H01M 4/505; H01M 4/525; H01M 4/5825; H01M 2004/028

(57) ABSTRACT

A battery cell includes a first cathode having a first active material composition, a second cathode having a second active material composition different than the first active material composition, and an anode disposed between the first cathode and the second cathode. The first active material composition may include, for example, lithium iron phosphate (LFP) or lithium manganese iron phosphate (LMFP), and the second active material composition may include, for example, lithium nickel manganese cobalt oxide (NMC).

### CROSS-REFERENCE TO RELATED APPLICATIONS

This application claims priority to U.S. Application No. 63/455,857, filed Mar. 30, 2023, entitled “HYBRID CATHODE STACK OF A BATTERY CELL,” which is incorporated by reference herein in its entirety for all purposes.

### BACKGROUND

The present disclosure relates generally to a battery cell. More specifically, the present disclosure relates to electrodes of the battery cell and corresponding active material composition.

A battery cell may be formed by electrodes (e.g., anodes and cathodes), one or more separators, electrolyte, a housing, terminals, and other possible componentry. The battery cell may be employed as a source of power for an electronic device. In certain battery cells, such as certain secondary (e.g., rechargeable) battery cells, the electrodes may be stacked and disposed in a housing (e.g., pouch) of the battery cell. Traditionally, a type of electrode (e.g., a type of the cathode) may be selected based on desired properties of the battery cell, such as a desired capacity, temperature threshold corresponding to thermal runaway, cost, and/or other properties. Often, these factors are in competition with one another. For example, a first type of cathode having a first active material composition may enable a higher capacity of the battery cell than a second type of cathode having a second active material composition, but the first type of cathode may be more susceptible to thermal runaway than the second type of cathode. In this way, in traditional configurations, electrode (e.g., cathode) selection may favor certain properties of the battery cell over other properties of the battery cell.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a battery cell includes a first cathode having a first active material composition, a second cathode having a second active material composition different than the first active material composition, and an anode disposed between the first cathode and the second cathode.

In another embodiment, a battery pack includes a first battery cell having a first housing, a first cathode disposed in the first housing and including a first active material composition, and a second cathode disposed in the first housing and including a second active material composition different than the first active material composition. The battery pack also includes a second battery cell having a second housing, a third cathode disposed in the second housing and including the first active material composition, and a fourth cathode disposed in the second housing and including the second active material composition. A first size of the first housing is substantially the same as a second size of the second housing.

In yet another embodiment, a method of manufacturing a battery cell includes forming a first cathode with a first active material composition, forming a second cathode with a second active material composition different than the first active material composition, and forming an anode with a third active material composition different than the first active material composition and the second active material composition. The method also includes disposing the first cathode and the second cathode on opposing sides of the anode.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a schematic diagram of a battery pack including a number of battery cells, each battery cell including a first cathode with a first active material composition and a second cathode with a second active material composition, according to embodiments of the present disclosure;

FIG. 2 is a schematic diagram of an electrode assembly of one battery cell of the battery pack of FIG. 1, in which the electrode assembly includes two different cathode types where an active material composition differs between the two different cathode types, according to embodiments of the present disclosure;

FIG. 3 is a schematic diagram of an electrode assembly of one battery cell of the battery pack of FIG. 1, in which the electrode assembly includes three different cathodes types, where an active material composition differs between the three different cathode types, according to embodiments of the present disclosure;

FIG. 4 is a schematic diagram of an electrode assembly of one battery cell of the battery pack of FIG. 1, in which the electrode assembly includes three different cathodes types, where an active material composition differs between the three different cathode types and an arrangement of the three different cathode types differs from the electrode assembly in FIG. 4, according to embodiments of the present disclosure; and

FIG. 5 is a process flow diagram illustrating a method of manufacturing one of the battery cells of the battery pack of FIG. 1, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure relates generally to electrodes (e.g., cathodes) in a battery cell. More specifically, the present disclosure relates to a hybrid electrode stack of the battery cell, where the hybrid electrode stack includes a first electrode (e.g., a first cathode) of a first type (e.g., first active material composition) and a second electrode (e.g., a second cathode) of a second type (e.g., second active material composition) differing from the first type.

In accordance with the present disclosure, a battery cell (e.g., a secondary or rechargeable battery cell, such as a lithium-ion battery cell) may include electrodes (e.g., cathodes and anodes), electrode tabs extending from bodies of the electrodes, electrolyte, one or more separators configured to separate the electrodes, a housing (e.g., metal can or pouch), terminals, and other possible componentry. For example, the housing may define a housing interior configured to receive the electrodes, the one or more separators, and the electrolyte. The electrode tab of each electrode may be electrically coupled with a positive battery terminal tab or a negative battery terminal tab, which may extend outside of the housing interior and are configured to be coupled to a load (e.g., an electric device powered by the battery).

A first cathode of the battery cell may include a first active material composition, such as lithium iron phosphate (LFP) or lithium manganese iron phosphate (LMFP) (e.g., having an olivine crystal structure). A second cathode of the battery cell may include a second active material composition, such as lithium nickel manganese cobalt oxide (NMC) (e.g., having a layered oxide crystal structure). In general, LFP and/or LMFP may be less expensive and more stable (e.g., a higher temperature threshold corresponding to thermal runaway) than certain other types of cathodes having different active material compositions, whereas NMC may include a higher energy density than certain other types of cathodes having different active material compositions. By including the first cathode having LFP or LMFP as the first active material composition and the second cathode having NMC as the second active material composition, the battery cell may be relatively more stable than certain traditional configurations, may be relatively less expensive than certain traditional configurations, and may include relatively higher energy density than certain traditional configurations.

An anode with a third active material composition (e.g., graphite, or non-graphite carbons, or silicon-containing materials, such as silicon-carbon composite, silicon monoxide, silicon metal oxide, or silicon metal alloy) may be disposed between the first cathode and the second cathode described above. Further, the battery cell may include multiple anodes and more than the first and second cathodes described above. As an example, the battery cell may include the first cathode having the first active material composition (e.g. LFP or LMFP), the second cathode having the second active material composition (e.g., NMC), the anode having the third active material composition (e.g., graphite or silicon-containing materials or their mixture) and positioned between the first cathode and the second cathode, a third cathode having the first active material composition (e.g., LFP or LMFP), an additional anode having the third material composition (e.g., graphite or silicon-containing materials or their mixture) and positioned between the second cathode and the third cathode, and so on and so forth. Other configurations are also possible. For example, the first active material composition may differ from LFP or LMFP, and the second active material composition may differ from NMC. Further, in certain embodiments, three different types of cathodes (e.g., having a respective three different types of active material compositions) may be employed. These and other configurations will be described in detail with reference to later drawings.

Further, a battery pack in accordance with the present disclosure may employ multiple instances of the above-described battery cell, where the multiple instances of the battery cell are disposed in an enclosure of the battery pack, electrically connected (e.g., via a bus assembly) to form an interconnected group of battery cells within the enclosure, and configured to output power to a load. Because each instance of the battery cell within the battery pack may be substantially the same (e.g., same size and shape) in accordance with present embodiments, the battery pack may be more easily assembled than other battery pack configurations employing, for example, a first battery cell having a first size dependent on the use of a first type of cathode and not a second type of cathode, and a second battery cell having a second size dependent on the use the second type of cathode and not the first type of cathode, where the first size differs from the second size. These and other features will be described in detail below with reference to the drawings.

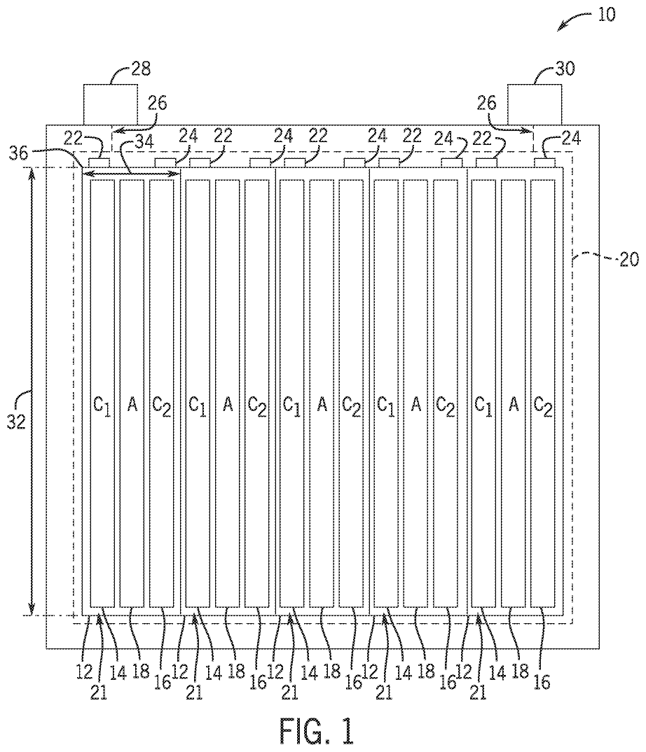

FIG. 1 is a schematic diagram of an embodiment of a battery pack 10 including a number of battery cells 12, each battery cell 12 including a first cathode 14 with a first active material composition, such as lithium iron phosphate (LFP) or lithium manganese iron phosphate (LMFP), and a second cathode 16 with a second active material composition, such as lithium nickel manganese cobalt oxide (NMC). Each battery cell also includes an anode 18 disposed between the first cathode 14 and the second cathode 16. The anode 18 may include, for example, an active material composition including graphite, or non-graphite carbons, or silicon-containing materials (e.g., silicon-carbon composite, silicon monoxide, silicon metal oxide, or silicon metal alloy).

As described above, the first active material composition of the first cathode 14 may include LFP or LMFP, and the second active material composition of the second cathode 16 may include NMC. Other embodiments may include other active material compositions in the first cathode 14 or the second cathode 16. For example, LFP, LMFP, NMC, lithium cobalt oxide (LCO), lithium nickel cobalt aluminum oxide (NCA), lithium nickel cobalt manganese aluminum oxide (NCMA), lithium nickel manganese oxide (NMX, cobalt-free layered oxide), or lithium manganese oxide (LMO, LiMn₂O₄) may be included as the active material composition in the first cathode 14 or the second cathode 16. In general, presently disclosed embodiments include different active material compositions between the first cathode 14 and the second cathode 16.

In some embodiments, the first cathode 14 may include an active material composition with an olivine crystal structure (e.g., LMFP or LFP) and the second cathode 16 may include an active material composition with a layered oxide crystal structure (e.g., NMC, LCO, NCA, NCMA, or NMX) (e.g., for increased energy and power relative to certain other battery configurations). In other embodiments, the first cathode 14 may include an active material composition with an olivine crystal structure (e.g., LMFP or LFP) and the second cathode 16 may include an active material composition with a spinel crystal structure (e.g., LMO) (e.g., for increased power without sacrificing safety or stability relative to certain other battery configurations). In other embodiments, the first cathode 14 may include an active material composition with the layered oxide crystal structure (e.g., NMC, LCO, NCA, NCMA, or NMX) and the second cathode 16 may include an active material composition with the spinel crystal structure (e.g., LMO) (e.g., for reduced cost and improved safety relative to certain other battery configurations).

As will be described with reference to later drawings, in other embodiments, a third cathode with a third material composition may also be employed, where the first cathode 14 includes an active material composition with the olivine crystal structure (e.g., LMFP or LFP), the second cathode 16 includes an active material composition with the layered oxide crystal structure (e.g., NMC, LCO, NCA, NCMA, or NMX), and the third cathode (not shown in FIG. 1) includes an active material composition with the spinel crystal structure (e.g., LMO) (e.g., for balanced energy, power, and safety or stability).

In general, presently disclosed embodiments include a first active material composition in the first cathode 14 and a second active material composition in the second cathode 16, where the first active material composition is different than the second active material composition. In doing so, the battery cells 12 may provide a multitude of benefits associated with each of the active material compositions employed in the cathodes 14, 16. As an example, LFP and LMFP are relatively stable and inexpensive, whereas NMC enables a relatively high energy density. Accordingly, employing LFP or LMFP as the first active material composition in the first cathode 14 may improve a stability of the battery cells 12 and save cost on the battery cells 12 relative to certain traditional configurations, and employing NMC as the second active material composition in the second cathode 16 may improve energy density and/or capacity of the battery cells 12 relative to certain traditional configurations.

Although each battery cell 12 in the illustrated embodiment includes the first cathode 14, the second cathode 16, and the anode 18 disposed between the first cathode 14 and the second cathode 16, it should be understood that more instances of the first cathode 14, the second cathode 16, and the anode 18 may be employed in each battery cell 12 in accordance with the present disclosure. In general, each pair of cathodes 14, 16 may include an instance of the anode 18 therebetween. As an example, each battery cell 12 may include a first instance of the first cathode 14, a first instance of the second cathode 16, a first instance of the anode 18 between the first instances of the first cathode 14 and the second cathode 16, a second instance of the first cathode 14, a second instance of the second cathode 16, and a second instance of the anode 18 between the second instances of the first cathode 14 and the second cathode 16.

In some embodiments, a total combined number of the cathodes (e.g., a sum of the first cathodes 14 and the second cathodes 16) may be within a range of 15-100, 20-80, 25-60, 30-40, 15 or less, 100 or more, and so on. Other arrangements, configurations, and/or orderings of various instances of the first cathode 14, the second cathode 16, and the anode 18 may be employed. Further, in certain embodiments, a third cathode (not shown) including a third active material composition differing from the first active material composition of the first cathode 14 and the second active material composition of the second cathode 16 may also be employed. In accordance with the present disclosure, each electrode assembly 21 of various electrodes (e.g., cathodes 14, 16 and anodes 18) in each battery cell 12 may be referred to as a hybrid cathode stack, which denotes that the electrode assembly 21 includes at least two different types of cathodes (e.g., the first cathode 14 including the first active material composition and the second cathode 16 including the second active material composition). These and other features will be described in detail with reference to the drawings.

In the illustrated embodiment, the battery cells 12 may be electrically coupled (e.g., in series, in parallel, or in a combination of series and parallel) via battery cell terminals 22, 24 of the battery cells 12 to form an electrically interconnected group 20 of the battery cells 12. For example, bus bars may be employed to couple the battery cell terminals 22, 24 to form the electrically interconnected group 20 of the battery cells 12. The bus bars may belong to a bus assembly 26 employed to couple the electrically interconnected group 20 of the battery cells 12 to battery pack terminals 28, 30 of the battery pack 10, where the battery pack terminals 28, 30 are configured to couple the battery pack 10 with a load powered by the battery pack 10. In some embodiments, additional bus assemblies and/or battery pack terminals may be employed to couple the battery pack 10 with a number of different loads (e.g., loads including different power requirements).

As shown, the battery pack 10 includes multiple instances of the same battery cell 12. That is, each battery cell 12 of the battery pack 10 may be substantially the same in certain embodiments. For example, a height 32, a width 34, and a length 36 of each battery cell 12 may be substantially the same. Accordingly, in addition to the above-described technical benefits associated with using different active material compositions in different cathodes (e.g., the first cathode 14 and the second cathode 16) of a single battery cell 12, assembly and manufacturing of the battery pack 10 may be improved over certain tradition configurations that employ different sized battery cells.

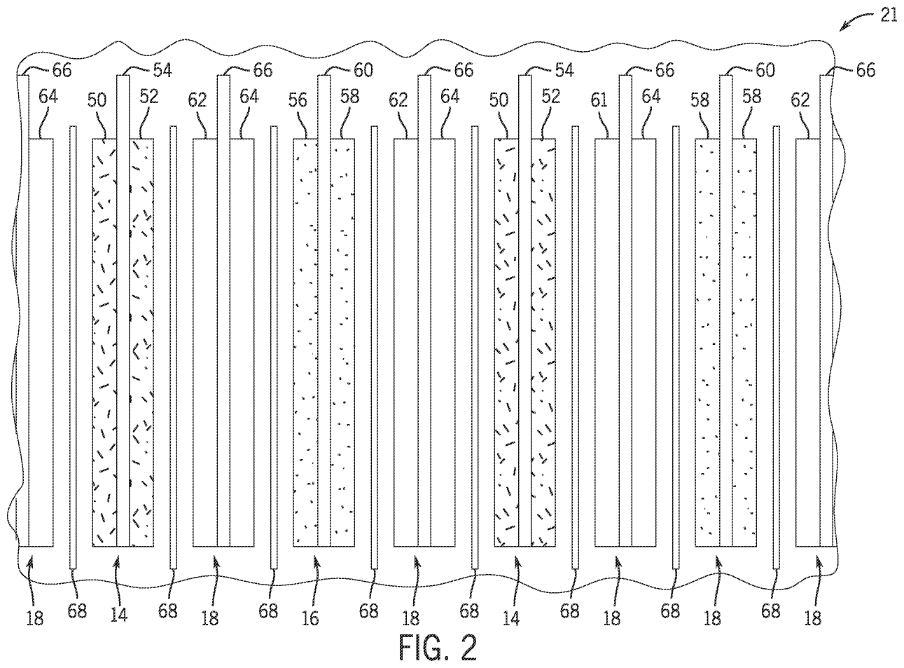

FIG. 2 is a schematic diagram of an embodiment of the electrode assembly 21 of one battery cell 12 of the battery pack 10 of FIG. 1, in which the electrode assembly 21 includes two different cathode types where an active material composition differs between the two different cathode types. For example, the electrode assembly 21 includes various instances of the first cathode 14 having a first active material composition (e.g., LFP or LMFP), various instances of the second cathode having a second active material composition (e.g., NMC), and various instances of the anode 18. As previously described, the active material composition of the anode 18 may be graphite, non-graphitic carbons, or silicon-containing materials (e.g., silicon-carbon composite, silicon monoxide, silicon metal oxide, or silicon metal alloy).

Each instance of the first cathode 14 in the illustrated embodiment may include a first cathode layer 50 and a second cathode layer 52 disposed on opposing sides of a current collector 54 (e.g., aluminum foil) of the first cathode 14. The first cathode layer 50 and the second cathode layer 52 of each first cathode 14 may both include the first active material composition (e.g., LFP or LMFP) and not the second active material composition (e.g., NMC) corresponding to the second cathode 16. Further, each instance of the second cathode 16 in the illustrated embodiment may include a first cathode layer 56 and a second cathode layer 58 disposed on opposing sides of a current collector 60 (e.g., aluminum foil) of the second cathode 16. The first cathode layer 56 and the second cathode layer 58 of each second cathode 16 may both include the second active material composition (e.g., NMC) and not the first active material composition (e.g., LFP or LMFP) corresponding to the second cathode 16. Further still, each instance of the anode 18 in the illustrated embodiment may include a first anode layer 62 and a second anode layer 64 disposed on opposing sides of a current collector 66 (e.g., copper foil). The first anode layer 62 and the second anode layer 64 of each anode 18 may include graphite or silicon-containing materials or their mixture as the active material composition. As shown, separator portions 68 may extend between the electrodes (e.g., anodes 18 and cathodes 14, 16).

The illustrated embodiment includes the first cathodes 14 and the second cathodes 16 arranged in alternating order, such that the electrode assembly 21 includes, for example, the same number of first cathodes 14 and second cathodes 16. However, in certain embodiments, the first cathodes 14 and the second cathodes 16 may not be arranged in alternating order. Other arrangements and configurations will be described in detail below, and may include a greater number of the first cathodes 14 than the second cathodes 16. For example, 90% of the total number of cathodes may be the first cathodes 14 and 10% of the total number of cathodes may be the second cathodes 16, 70% of the total number of cathodes may be the first cathodes 14 and 30% of the total number of cathodes may be the second cathodes 16, etc.

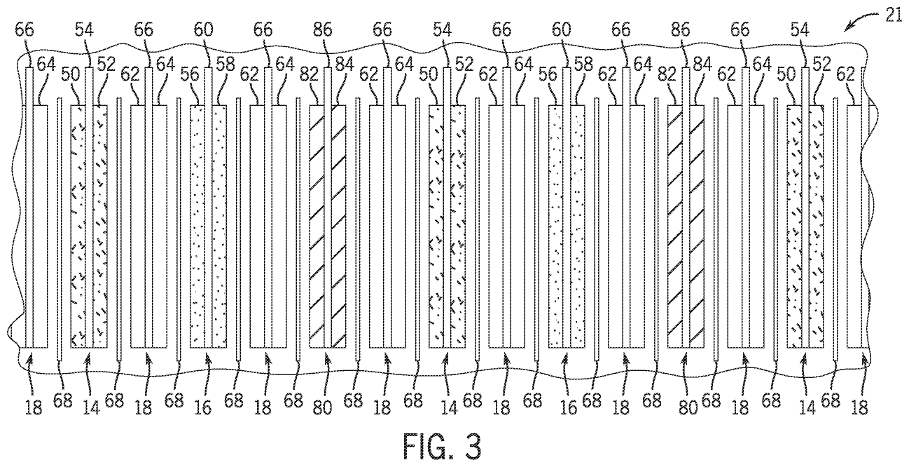

FIG. 3 is a schematic diagram of an embodiment of the electrode assembly 21 of one battery cell 12 of the battery pack 10 of FIG. 1, in which the electrode assembly 21 includes three different cathodes types, where an active material composition differs between the three different cathode types. For example, the electrode assembly 21 (which may be referred to as a hybrid cathode stack) includes the first cathodes 14 having the first active material composition, the second cathodes 16 having the second active material composition, the anodes 18, and the separator portions 68. Further, the electrode assembly 21 in FIG. 3 includes third cathodes 80 having a third active material composition different than the first active material composition of the first cathodes 14 and the second active material composition of the second cathodes 16. Each of the third cathodes 80 may include a first cathode layer 82 and a second cathode layer 84 disposed on opposing sides of a current collector 86 (e.g., aluminum foil).

In the illustrated embodiment, the first cathodes 14, the second cathodes 16, and the third cathodes 80 are placed in repeated, alternating order. That is, from left to right, the electrode assembly 21 includes an instance of the anode 18, then an instance of the first cathode 14, then an instance of the anode 18, then an instance of the second cathode 16, then an instance of the anode 18, then an instance of the third cathode 80, then an instance of the anode 18, then an instance of the first cathode 14, then an instance of the anode 18, then an instance of the second cathode 16, then an instance of the anode 18, then an instance of the third cathode 80, and so on and so forth. Of course, the separator portions 68 are disposed between each adjacent pair of electrodes. Other arrangements and configurations of the cathodes 14, 16, 80 are also possible, as described in detail below.

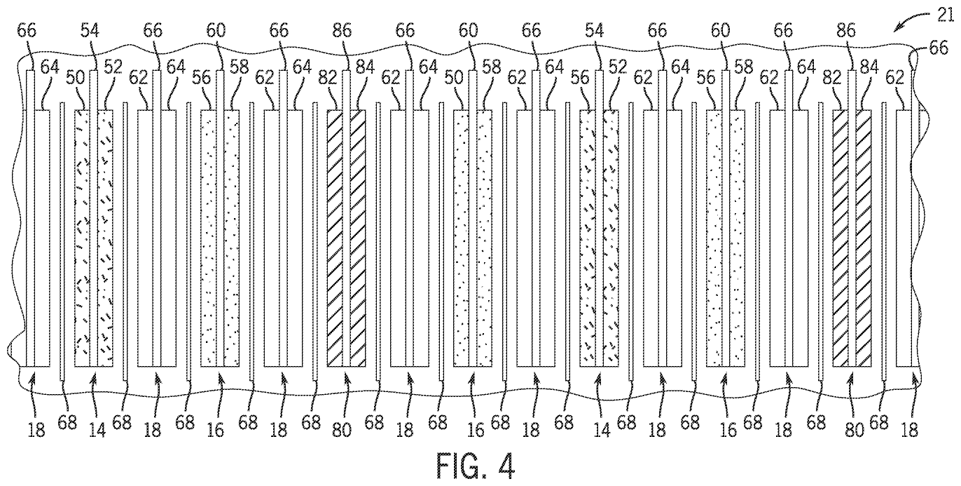

FIG. 4 is a schematic diagram of an embodiment of the electrode assembly 21 of one battery cell 12 of the battery pack 10 of FIG. 1, in which the electrode assembly 21 includes three different cathodes types, where an active material composition differs between the three different cathode types and an arrangement of the three different cathode types differs from the electrode assembly 21 in FIG. 3. For example, the electrode assembly 21 in FIG. 4 includes the first cathodes 14, the second cathodes 16, and the third cathodes 80. However, the arrangement or configuration of the three cathodes 14, 16, 80 in FIG. 4 differs from the arrangement or configuration of the three cathodes 14, 16, 80 in FIG. 3.

For example, the electrode assembly 21 in FIG. 4, starting from the left and working toward the right, includes an instance of the anode 18, then an instance of the first cathode 14, then an instance of the anode 18, then an instance of the second cathode 16, then an instance of the anode 18, then an instance of the third cathode 80, then an instance of the anode 18, then an instance of the second cathode 16, then an instance of the anode 18, then an instance of the first cathode 14, then an instance of the anode 18, then an instance of the second cathode 16, then an instance of the anode 18, then an instance of the third cathode 80, then an instance of the anode 18, and so on and so forth. Of course, the separator portions 68 are disposed between each adjacent pair of electrodes. Other arrangements and configurations are also possible, as described in detail below.

FIGS. 1-4 include various configurations of embodiments of the electrode assembly 21. However, the present disclosure is not limited to these embodiments. In general, the present disclosure includes various instances of the electrode assembly 21 including at least two different types of cathodes (e.g., where “type” references the active material composition of the cathode). Three or more different types of cathodes may be employed in certain embodiments. Further, different arrangements and configurations of the various types of cathodes are possible. For example, a first type of cathode may be referred to below as Type A, and a second type of cathode may be referred to below as Type B.

An embodiment of the electrode assembly 21 may include the following order of electrodes: Type A cathode, anode, Type B cathode, anode, Type A cathode, anode, Type B cathode, etc. Another embodiment of the electrode assembly 21 may include the following order of electrodes: Type A cathode, anode, Type A cathode, anode, Type B cathode, anode, Type B cathode, anode, Type A cathode, anode, Type A cathode, anode, Type B cathode, anode, Type B cathode, etc. Another embodiment of the electrode assembly 21 may include the following order: Type A cathode, anode, Type A cathode, anode, Type B cathode, anode, Type A cathode, anode, Type A cathode, anode, Type B cathode, etc. Another embodiment of the electrode assembly 21 may include the following order: Type A cathode, anode, Type A cathode, anode, Type A cathode, anode, Type B cathode, anode, Type B cathode, anode, Type A cathode, anode, Type A cathode, anode, Type A cathode, anode, Type B cathode, anode, Type B cathode, etc. Other arrangements, configurations, or orderings are also possible.

Of course, as previously described, more than two types of cathodes may be employed in the electrode assembly 21, such as the Type A cathode, the Type B cathode, and a Type C cathode. An embodiment of the electrode assembly 21 may include the following order: Type A cathode, anode, Type B cathode, anode, Type C cathode, anode, Type A cathode, anode, Type B cathode, anode, Type C cathode, etc. Another embodiment of the electrode assembly 21 may include the following order: Type A cathode, anode, Type B cathode, anode, Type C cathode, anode, Type B cathode, anode, Type A cathode, anode, etc. Another embodiment of the electrode assembly 21 may include the following order: Type A cathode, anode, Type B cathode, anode, Type C cathode, anode, Type C cathode, anode, Type B cathode, anode, Type A cathode, etc. Another embodiment of the electrode assembly 21 may include the following order: Type A cathode, anode, Type B cathode, anode, Type A cathode, anode, Type C cathode, anode, Type A cathode, anode, Type B cathode, anode, Type C cathode, etc. Another embodiment of the electrode assembly 21 may include the following order: Type A cathode, anode, Type A cathode, anode, Type B cathode, anode, Type B cathode, anode, Type C cathode, anode, Type C cathode, etc. Another embodiment of the electrode assembly 21 may include the following order: Type A cathode, anode, Type A cathode, anode, Type B cathode, anode, Type C cathode, anode, Type A cathode, anode, Type A cathode, anode, Type B cathode, anode Type C cathode, anode.

The above-described embodiments of the electrode assembly 21 are merely examples and are not limiting on other arrangements in accordance with the present disclosure. In general, the present disclosure is directed toward instances of the electrode assembly 21 in which two or more different types of cathodes (e.g., having different types of active material compositions) are employed in a single battery cell.

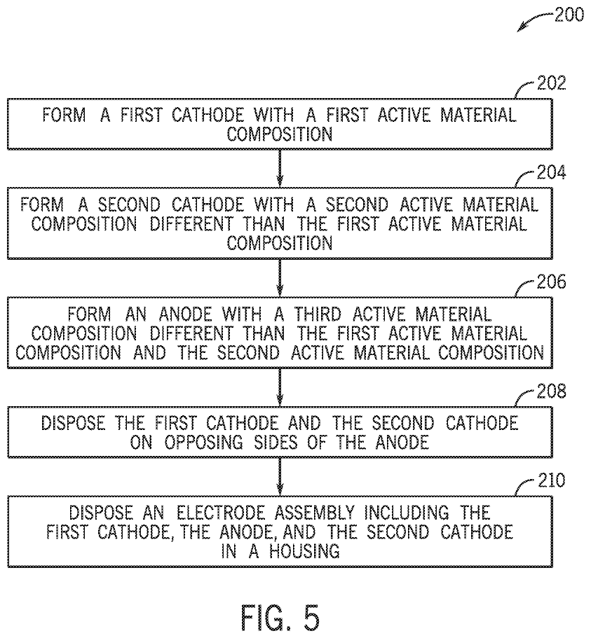

FIG. 5 is a process flow diagram illustrating an embodiment of a method 200 of manufacturing one of the battery cells 12 of the battery pack 10 of FIG. 1. The method 200 includes forming (block 202) a first cathode with a first active material composition. The first cathode may include a first cathode layer and a second cathode layer disposed on opposing sides of a current collector (e.g., aluminum foil), where both the first cathode layer and the second cathode layer include the first active material composition.

The method 200 also includes forming (block 204) a second cathode with a second active material composition different than the first active material composition. The second cathode may include a first cathode layer and a second cathode layer disposed on opposing sides of a current collector (e.g., aluminum foil), where both the first cathode layer and the second cathode layer include the second active material composition.

The method also includes forming (block 206) an anode with a third active material (e.g., graphite or silicon-containing materials or their mixture) different than the first active material and the second active material. The anode may include a first anode layer and a second anode layer disposed on opposing sides of a current collector (e.g., copper foil), where both the first anode layer and the second anode layer include the third active material composition.

The method also includes disposing (block 208) the first cathode and the second cathode on opposing sides of the anode. Further a first separator portion may be disposed between the first cathode and the anode, and a second separator portion may be disposed between the second cathode and the anode.

The method also includes disposing (block 210) an electrode assembly including the first cathode, the anode, and the second cathode in a housing of the battery cell. It should be understood that the electrode assembly may include a number of instances of the first cathode, a number of instances of the anode, and a number of instances of the second cathode forming a stack disposed in the housing. Further, as previously described, a third cathode including an active material composition different than that of the first cathode and the second cathode may also be employed in the stack. As previously described, the active material compositions of the various cathodes may each include one of LFP, LMFP, NMC, LCO, NCA, NCMA, NMX, or LMO. In general, the battery cell is manufactured such that at least two different types of cathodes (e.g., having different active material compositions) are included in the electrode assembly, which may be referred to as a hybrid cathode stack of the battery cell. It should be understood that the method 200 described above may include additional steps, such as sealing the housing (e.g., pouch), attaching the electrodes to battery cell terminals (e.g., via electrode tabs), etc.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

1. A battery cell, comprising:
a first cathode having a first active material composition;
a second cathode having a second active material composition different than the first active material composition; and
an anode disposed between the first cathode and the second cathode.

2. The battery cell of claim 1, wherein:
the first active material composition comprises lithium iron phosphate (LFP) or lithium manganese iron phosphate (LMFP); and
the second active material composition comprises:
lithium nickel manganese cobalt oxide (NMC); or
lithium cobalt oxide (LCO); or
lithium nickel cobalt aluminum oxide (NCA); or
lithium nickel cobalt manganese aluminum oxide (NCMA); or
lithium nickel manganese oxide (NMX); or
lithium manganese oxide (LMO).

3. The battery cell of claim 1, comprising:
a third cathode having the first active material composition; and
an additional anode disposed between the second cathode and the third cathode.

4. The battery cell of claim 3, wherein the second cathode is disposed between the anode and the additional anode.

5. The battery cell of claim 1, comprising:
a third cathode having a third active material composition different than the first active material composition and the second active material composition; and
an additional anode disposed between the second cathode and the third cathode.

6. The battery cell of claim 1, wherein the anode comprises graphite, non-graphitic carbons, or silicon-containing materials, or a mixture thereof.

7. The battery cell of claim 1, comprising:
a first current collector, wherein the first cathode comprises a first cathode layer and a second cathode layer disposed on opposing sides of the first current collector;
a second current collector, wherein the second cathode comprises a third cathode layer and a fourth cathode layer disposed on opposing sides of the second current collector; and
a third current collector, wherein the anode comprises a first anode layer and a second anode layer disposed on opposing sides of the third current collector.

8. The battery cell of claim 1, comprising:
separators and electrolyte;
a housing in which the first cathode, the anode, and the second cathode are disposed;
a first battery cell terminal protruding from the housing; and
a second battery cell terminal protruding from the housing.

9. A battery pack, comprising:
a first battery cell having a first housing, a first cathode disposed in the first housing and including a first active material composition, and a second cathode disposed in the first housing and including a second active material composition different than the first active material composition; and
a second battery cell having a second housing, a third cathode disposed in the second housing and including the first active material composition, and a fourth cathode disposed in the second housing and including the second active material composition, wherein a first size of the first housing is substantially the same as a second size of the second housing.

10. The battery pack of claim 9, wherein:
the first active material composition comprises an olivine crystal structure; and
the second active material composition comprises a layered oxide crystal structure.

11. The battery pack of claim 9, wherein:
the first battery cell comprises a first anode disposed in the first housing between the first cathode and the second cathode; and
the second battery cell comprises a second anode disposed in the second housing between the third cathode and the fourth cathode.

12. The battery pack of claim 9, wherein:
the first battery cell comprises a fifth cathode disposed in the first housing and including the first active material composition;
the second cathode is disposed between the first cathode and the fifth cathode;
the second battery cell comprises a sixth cathode disposed in the second housing and including the first active material composition; and
the fourth cathode is disposed between the third cathode and the sixth cathode.

13. The battery pack of claim 9, wherein:
the first battery cell comprises a fifth cathode disposed in the first housing and including a third active material composition different than the first active material composition and the second active material composition; and
the second battery cell comprises a sixth cathode disposed in the second housing and including the third active material composition.

14. The battery pack of claim 9, wherein:
the first battery cell comprises a first current collector disposed between a first cathode layer of the first cathode and a second cathode layer of the first cathode;
the first battery cell comprises a second current collector disposed between a third cathode layer of the second cathode and a fourth cathode layer of the second cathode;
the second battery cell comprises a third current collector disposed between a fifth cathode layer of the third cathode and a sixth cathode layer of the third cathode; and
the second battery cell comprises a fourth current collector disposed between a seventh cathode layer of the fourth cathode and an eighth cathode layer of the fourth cathode.

15. The battery pack of claim 9, comprising:
a first battery pack terminal;
a second battery pack terminal; and
a plurality of interconnected battery cells including the first battery cell and the second battery cell, wherein the plurality of interconnected battery cells is coupled to the first battery pack terminal and the second battery pack terminal via a bus assembly.

16. A method of manufacturing a battery cell, comprising:
forming a first cathode with a first active material composition;
forming a second cathode with a second active material composition different than the first active material composition;
forming an anode with a third active material composition different than the first active material composition and the second active material composition; and
disposing the first cathode and the second cathode on opposing sides of the anode.

17. The method of claim 16, comprising:
forming a third cathode with the first active material composition;
forming an additional anode with the third active material composition; and
disposing the second cathode and the third cathode on opposing sides of the additional anode such that the second cathode is between the anode and the additional anode.

18. The method of claim 16, comprising:
forming a third cathode with a fourth active material composition different than the first active material composition, the second active material composition, and the third active material composition;
forming an additional anode with the third active material composition; and
disposing the second cathode and the third cathode on opposing sides of the additional anode such that the second cathode is between the anode and the additional anode.

19. The method of claim 16, comprising:
forming the first cathode with the first active material composition corresponding to lithium iron phosphate (LFP) or lithium manganese iron phosphate (LMFP); and
forming the second cathode with the second active material composition corresponding to:
lithium nickel manganese cobalt oxide (NMC); or
lithium cobalt oxide (LCO); or
lithium nickel cobalt aluminum oxide (NCA); or
lithium nickel cobalt manganese aluminum oxide (NCMA); or
lithium nickel manganese oxide (NMX); or
lithium manganese oxide (LMO).

20. The method of claim 16, comprising:
disposing a first cathode layer of the first cathode and a second cathode layer of the first cathode on opposing sides of a first current collector; and
disposing a third cathode layer of the second cathode and a fourth cathode layer of the second cathode on opposing sides of a second current collector.
